(19) United States
(12) Patent Application Publication
(10) Pub. No.: US 2010/0191622 A1
(43) Pub. Date: Jul. 29, 2010

(54) Distributed Transaction layer

(76) Inventors: Zvi Reiss, Brooklyn, NY (US); Alexander Green, Brooklyn, NY (US)

Correspondence Address: Law Office of Michael J. Feigin, 103 The Circle, (http://PatentLawNY.com), Passaic, NJ, 07055, US

(21) Appl. No.: 12/360,880

(22) Filed: Jan. 28, 2009

(51) Int. Cl. G06Q 20/00; G06Q 10/00

(52) U.S. Cl. 705/30; 705/44

(57) ABSTRACT

The disclosed technology is of a transaction layer allowing for security and trust between parties sending and receiving funds. The technology allows any company or entity to become a host server to host user accounts for sending and receiving money and is backup up by one or a plurality of secure registry servers which point users to a correct host server. Substantially any electronic-enabled payment method known in the art, so long as it is negotiable between a payor and payee, may be used with embodiments of the disclosed technology and sensitive data may be hidden from the other party. Gift cards and third party payments are also contemplated as being part of the disclosed technology.

### FIELD OF THE DISCLOSED TECHNOLOGY

The disclosed technology relates generally to transactions and, more specifically, to a distributed layer for conducting a transaction.

### BACKGROUND OF THE DISCLOSED TECHNOLOGY

Payment methods have been steadily advancing from precious metals as currency, to paper backed by precious metals, to paper itself, to checks, to credit cards, and to online payment methods and electronic accounts where money can be held, such as PayPal or others known in the art. In each case, varying degrees of trust between payor and payee are required, and varying degrees of information must change hands between a payor and payee. If a person pays with a check or credit card, data which can be used to deduct money in the future is also given to the other party. The payee, on the other hand, is not necessarily guaranteed that the money it is actually owed will be received. There may be insufficient funds, overdrawn credit, or simply, fraud. Monetary system designers are generally very concerned with providing greater levels of security, and online accounts have attempted to solve many of these problems, though such accounts require proprietary payment systems controlled by individual entities which dictate rates and fees.

Thus, one of the major obstacles with many monetary systems, by design, is that they tend to be closed systems for purposes of security and maximum profit. Until a central currency was developed in the United States, each state issued currency (and Rhode Island issued three), depending on the bank. Some cities still issue local currency. Similarly today, if one wants to pay with a credit card, one must use one of only a few existing companies. If one wants to pay via an electronic account, one must hold an account at the same company as the payee and accept terms of such a company.

In other technologies, by contrast, the inherent design is open and distributed. For example, computer networks have long since been developed in such a way that anyone can connect into the system in a distributed manner. As is well known in the art, one can connect to a node on the internet and become a node himself. A database of internet protocol addresses is stored, including number to name lookup tables, and data is forwarded between computing devices as desired by any node on the network. The downside to such openness is the frequency of unwanted content, such as spam, denial of service attacks, and so forth.

What is needed in the art is a method to combine the security of monetary systems with the openness of computer network architecture in such a manner as to obtain the benefits of both while eliminating the negative aspects of each.

### SUMMARY OF THE DISCLOSED TECHNOLOGY

It is therefore an object of the disclosed technology to provide a distributed system with a plurality of hosts, whereby each user of the system can create an account on any host to send money or receive a payment with any other user.

It is a further object of the disclosed technology to use such a system to allow users to send and receive money in a secure manner.

It is yet another object of the disclosed technology to allow users to receive authentication of money being sent or received and to automatically update accounting records accordingly.

It is yet another object of the disclosed technology to allow users to send payments by way of any existing monetary payment system which can be used via a computer network.

A method of completing a transaction in an embodiment of the disclosed technology proceeds by receiving authenticated information from a payee, the information having within it a request to transfer funds from a payor to the payee. A request is sent to a registry server to determine which host holds an account for the payor. Authenticated information is then exchanged with a host associated with the payor, based on the results of the request to a registry server. At least some of the authenticated information is sent to a funding target associated with the payee. Upon approval, instructions are sent to initiate a transfer of funds from a funding source associated with the payor to the funding target.

The payor may be associated with a first host and the payee may be associated with a second host. The first host may be operated by a first company and the second host may be operated by a second company. The request to transfer funds may comprise a selection of the funding source which may be from a group consisting of a check, a bank wire transfer, a credit card, or an electronic account.

The approval may comprise automated approval based on a trustworthiness threshold of at least the payor or payee, or the payor may provide the approval. Additionally, a bank, the payee, or a funding target may provide approval. An approval may result in authenticated information being sent to another party or intermediary to the transaction, in order to allow the transaction to proceed. An authenticated receipt or failure notice (the latter, if the transaction is declined for any reason by the funding source) may be sent at least to the payor and the payee, either or both of which may use the receipt to update their accounting information, such as within their accounting software.

Embodiments of the disclosed technology include the above-described method, as well as devices for carrying out the method of the disclosed technology and computer readable storage mediums with instructions to carry out embodiments of the disclosed technology.

### BRIEF DESCRIPTION OF THE DRAWINGS

FIG. 1 shows a high level block diagram of a network hierarchy in an embodiment of the disclosed technology.

FIG. 2 shows a high level block diagram of a money transfer hierarchy in an embodiment of the disclosed technology.

FIG. 3 shows steps taken to generate an invoice in an embodiment of the disclosed technology.

FIG. 4 shows the steps taken to generate a payment authorization in an embodiment of the disclosed technology.

FIG. 5 shows steps taken to pre-allocate and pre-authorize funds from a funding source to a payee in an embodiment of the disclosed technology.

FIG. 6 shows the steps taken in an embodiment of the disclosed technology where a payor causes an invoice to be generated.

FIG. 7 shows the steps taken to authorize a transaction when a payor interacts with a payee website in an embodiment of the disclosed technology.

FIG. 8 shows a high-level block diagram of a computer that may be used to carry out the disclosed technology.

### DETAILED DESCRIPTION OF EMBODIMENTS OF THE DISCLOSED TECHNOLOGY

Embodiments of the disclosed technology comprise a distributed and secure financial system for arranging the transfer of payments between parties. Authenticated information is received from a payee. The payee is associated with a host, also called a host server. The authenticated information received from the payee, that is a party who wishes to receive money from another, comprises a request to transfer funds from a payor to the payee which includes computer-readable data and is interpreted as such by a general purpose computer carrying out instructions.

A request is sent to a registry server, either previous to the request to transfer funds or after. One of the features of the registry server may be thought of as analogous to a domain name server, as is known in the art of name to internet domain name translation on the internet. The request may be a request to determine which host holds account information for a payor or to cache data from the registry server. Authenticated information is then exchanged with a host associated with the payor based on the results of the request to a registry server. At least some of the authenticated information is sent to a funding target associated with the payee. Upon approval, instructions are sent to initiate a transfer of funds from a funding source associated with the payor to the funding target.

Embodiments of the disclosed technology will become clearer in connection with a description of the figures.

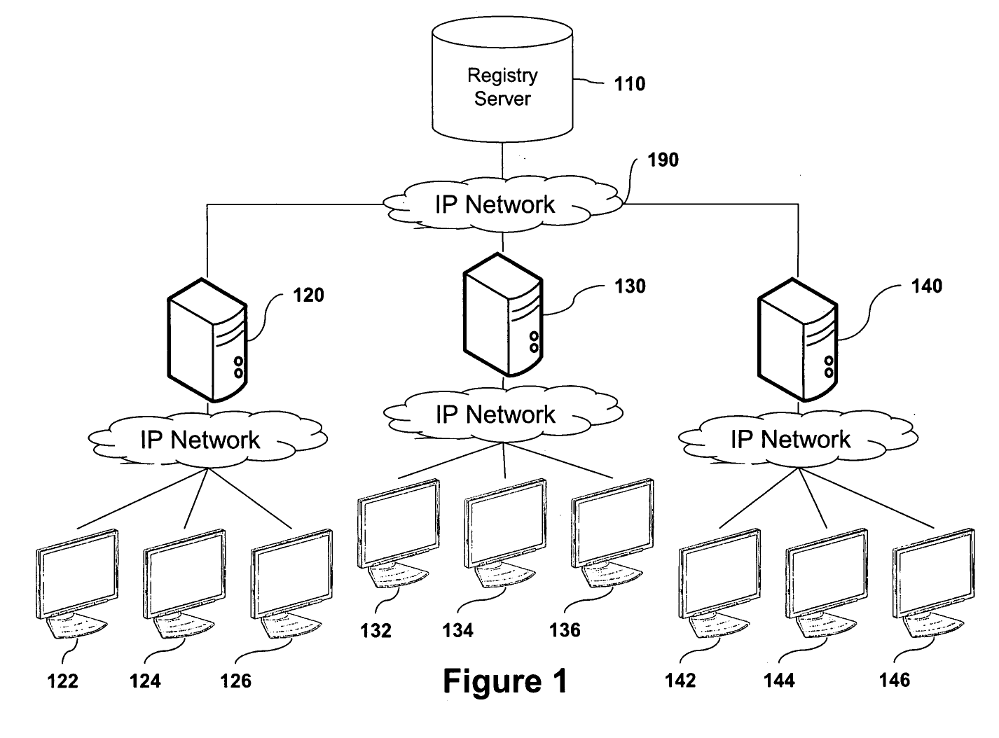

FIG. 1 shows a high level block diagram of a network hierarchy in an embodiment of the disclosed technology. A registry server 110 comprises data, such as in a database, which may be queried by host servers, such as host servers 120, 130, and 140. For security and licensing purposes, the host servers may have to register and be approved by a registry server in order to be part of the network infrastructure of embodiments of the disclosed technology. Registration with a registry server or any of the registry servers used in embodiments of the invention may require the approval of a company hosting the registry server(s), such as banks, payees, merchants, or the like who operate the registries. Registry servers may also be run by independent consortiums or the like. Encryption and other authentication schemes known in the art may be employed to ensure that data connections between the registry server 110 and any of the hosts are both secure and legitimate. While a single registry server 110 is shown, it should be understood that more than one registry server may be used, though the registry servers are typically all under a centralized control scheme with regard to the data transferred between them and to host servers. The data connection between the registry server 110 and any of the host servers may be over any network connection known in the art, such as but not limited to an IP (internet protocol) network connection 190, which may be over what is collectively known as the internet or over a direct transmission line or connection between hosts, registry servers, and/or payor's and payees. Such networks may enable communication between any of the devices shown in FIG. 1 to one another and may be an IP network as shown in FIG. 1 or any other type of network connection known in the art. A secure link between one or more host servers and each other and/or a registry server on a separate network may also be employed in embodiments of the disclosed technology. Any one of the host servers and/or registry servers may be operated on the same device, on separate devices, distributed over multiple devices, and/or operated by a single company or entity, or operated by different companies or entities. Any combination of a single registry server or plurality of registry servers and/or host servers operated by one or more tangible entities or companies is contemplated as being within the scope and spirit of the disclosed technology.

The host servers, such as host server 120, 130, and 140 may be one or more computing devices, such as general purpose computers or servers known in the art, comprising data, such as in the form of databases, having information with regard to user accounts. The users, in the example shown in FIG. 1, are users 122, 124, and 126 of host server 120; users 132, 134, and 136 of host server 130; and users 142, 144, and 146 of host server 140. The users may be financial institutions such as banks (traditional or electronic), individuals, companies, or the like. The users may be payors, i.e., those who send money to others, such as a customer, or payees, i.e., those who receive money such as a service or goods provider. In embodiments of the invention, each user is assigned a unique number, such as an account number or identification number which is used on the system. At times, a user may be a payor, and at another times, a payee, and the user may have two separate accounts, depending on usage. One person or entity may have multiple user accounts in embodiments of the disclosed technology. Each host server is associated with user accounts, that is, users have the ability to send instructions to a financial institution or devices of the disclosed technology to send or receive an invoice, a payment, or instruction to send same. A host, such as host 120, may be run by one or more companies, while a second host, such as host 130, may be run by another company. Accounts may be associated to, or linked with, already existing accounts on the host. For example, a webpage hosting company (such as an e-commerce service provider), an email provider, credit card processing company, bank, or the like, may operate a host, such as host 120, 130, or 140, and link already existing payment methods or the like to the disclosed technology. The function of hosts will be described in more detail with reference to figures to come.

Referring again to FIG. 1, the individual users interact, or exchange data, with their respective hosts in an authenticated manner, such as using encryption schemes known in the art, including transport level security protocols or secure socket layers. The hosts communicate with each other in a similar manner. The hosts may also query a registry server for data regarding which host is hosting a particular user, if any. The hosts, such as hosts 120, 130, or 140 communicate with one another to facilitate a transaction and notify a respective funding target to receive payment, as will be described in more detail below.

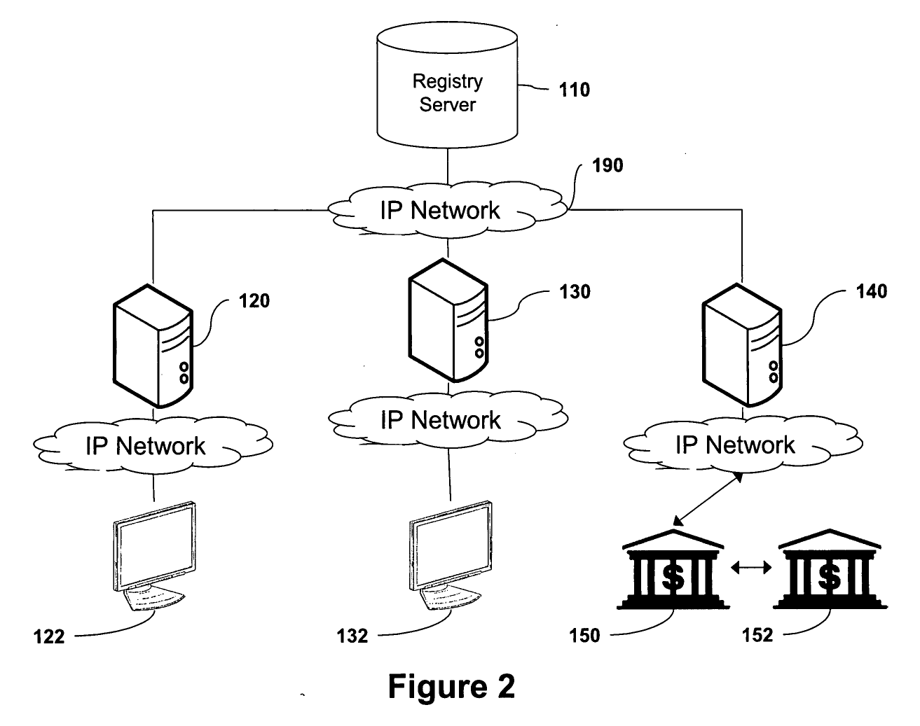

FIG. 2 shows a high level block diagram of a money transfer hierarchy in an embodiment of the disclosed technology. Where applicable, elements of the hierarchy are repeated from FIG. 1. In FIG. 2, host 120 is a host associated with a payor. Host 130 is a host associated with a payee. Host 140 is a host associated with a funding target, that is, a bank or other receptacle of money which accepts or holds money on behalf of the payee. It should, of course, be understood that a single device may serve more than one function shown in FIG. 2. For example, the host 130 of the payee and host 140 of the funding target may be the same host. Still further, “associated with” may mean that a user has an account on a particular host and/or is involved with a financial transaction on behalf of a user.

Financial institutions 150 and 152 (that is, any receptacle or forwarding entity of funds for a user) may be aware of the system and computer-implemented methods of the disclosed technology and be configured to work directly with them, or may be instructed by other devices, such as hosts, to initiate monetary transfers using protocols already known to them. Financial institution 150, in the example of FIG. 2, represents a funding target. Financial institution 152 represents a funding source. These financial institutions may exchange money with each other by way of any method known in the art, such as bank wire transfer, electronic accounts (e.g., PayPal), electronic check, credit card, or a combination thereof.

Payee 132 may send an invoice to payor 122 through hosts 130 and 120, respectively. Payor 122 may also seek to initiate a payment. Host 130 may be unfamiliar with payor 122, or host 120 may be unfamiliar with payee 132, and so may query a registry server 110 or look up in previously cached registry information which host is associated with payee 122. Each user on the system is assigned a unique identification code for purposes of location and security. In any case, cross authentication, that is host 120 and host 130, may each verify the validity and trustworthiness of any other host and any other user, as well as their own associated user. If the threshold of trustworthiness is too low, the monetary amount may be limited or the transaction not allowed. Trustworthiness may be based on the security of a host, the amount of verification of a user, prior fraudulent activity by a user or over a host, amount of dealings with a host or user, and so forth. In this manner, trust can be built up over time.

Payor 122, in embodiments of the disclosed technology, stores account information on host 120, such as credit card, bank, PayPal, or other information. Host 130, in embodiments of the disclosed technology, stores payment receipt information such as credit card merchant authorization data, PayPal account data, bank information, or the like. This may be integrated into existing payment systems, such as those described above, or e-commerce websites. The host may provide any reasonable and secure interface known in the art for its users, including a payment gateway integrated with an e-commerce website, dedicated software (web interface or residing on an individual's personal computer) for purposes of download invoices and sending payments, a transparent interface integrated with an existing payment method or system, and integration with software for related purposes, such as accounting or billing software.

Referring again to FIG. 2, as an overview, when a payment is sent, user 122 authorizes the payment in some form (manually or via preset automated methods) and host 120 receives this authorization from the user. Then, as described above, host 120 and host 130 communicate with each other to authenticate the transaction. When sending this authenticated information between payor and hosts, a payment method and account information may be specified, or it may be automatically negotiated or narrowed down between the parties based upon predefined rules. For example, the payee may only accept bank wires whereas the payor is willing to pay with credit card or bank wire. In such a case, bank wire may be selected. Host 120 (and/or host 130) then contacts host 140, the host associated with the bank, where applicable, in regard to the transaction. Authenticated information about the transaction is sent to host 140, which sends instructions to the financial institutions by passing on the authenticated information, or at least some of it (the data structure will be defined below) to the funding target 150 and/or funding source 152, or by sending a request which is known in the art to initiate a transfer of money (e.g., bank wire, electronic check, credit card charging, or PayPal information). The funding target, as described above, has or accepts money on behalf of the payee 132, and the funding source has funds or arranges to send payment on behalf of the payor 122. As will be described below, during any of the communications between payor 122, host 120, host 130, payor 132, host 140, funding source 150, and funding target 152, a notification or verification request may be sent to one or more of the parties involved in the transaction, in order to allow the transaction to be completed.

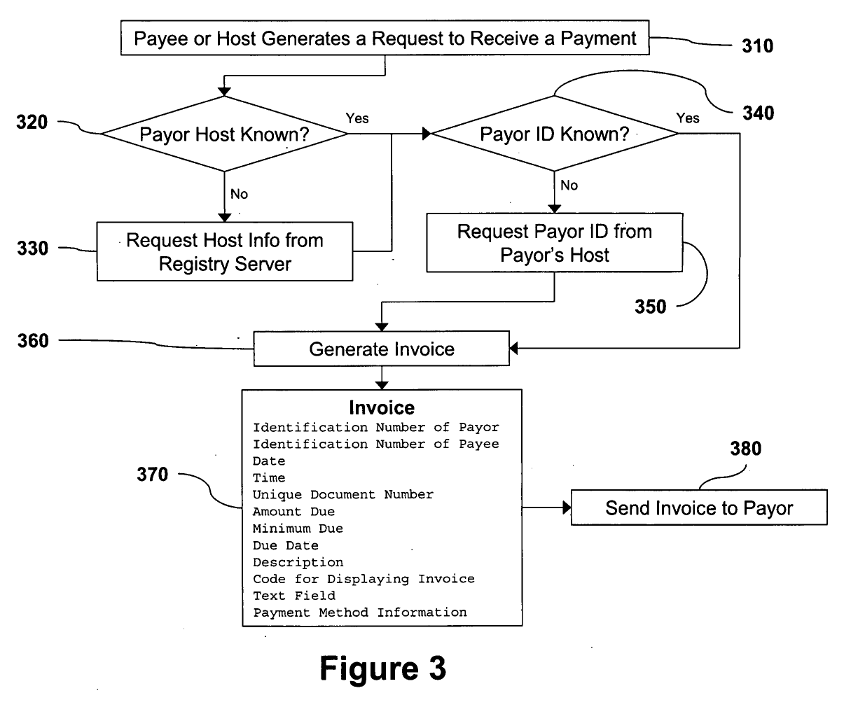

FIG. 3 shows steps taken to generate an invoice in an embodiment of the disclosed technology. The steps may be carried out in any order. For example, an invoice may be generated in step 370 before determining if the payor's host is known in step 320. The invoice may be any authenticated document with information readable by a computational device as instructions for sending a payment.

In step 310, a payee (such as user 132 of FIGS. 1 and 2) and/or a host associated with the payee (such as host 130) generates a request to receive a payment. This may be based upon interaction with a payor, such as a user placing an order on a website of the payee, or be a monthly bill, such as for a utility or credit card. In step 320, it is determined if the host of the payor is known. If not, then step 330 is carried out whereby a registry server (such as registry server 110) is queried, i.e., a request is sent out to the registry server, to determine, based on the known information, such as a username, payor ID, or other data referential to the payor, which host server holds the account of the payor. A general request to a host server may be made, for example, at regular time intervals, and data may be cached on an individual host for purposes of efficiency. In other embodiments of the disclosed technology, the registry server must be queried for each transaction to ensure accurate up-to-the-minute data and prevent fraud. In this manner, the registry server may also maintain logs and statistics of all transactions for fraud monitoring and billing purposes.

Once the payor host is known, in embodiments of the disclosed technology, or after a request for information from a registry server, step 340 is carried out. In step 340 it is determined if the payor ID (or customer number) is known. In embodiments the disclosed technology the payor's ID must be known to generate an invoice (i.e. the payor previously provided the ID to the payee). A registry server may be queried for the data, that is, which host serves the payor. The data from the registry server may have previously been queried and cached at the host of the payee. If not known, then in step 350, the payor's host is asked for this data. In embodiments of the disclosed technology, in order to prevent misuse, a trusted registry server is queried for each transaction. If fraud, a trust level below a threshold, or other incompatibilities (mismatch of available payment types) between the payor and payee are detected, the transaction may be declined at this time.

Step 350 may be carried out each time, in embodiments of the disclosed technology, so as to provide a further level of a security. That is, before an invoice or other request to receive or send payment is generated, the host of the payor is queried in embodiments of the disclosed technology to determine trust level, receive up to date information about the payor, and so forth. If this information matches what is already known or partially known by the host server of the payee, a level of trust may be established between the host and payor, and payee and payor. Too much changed information may be indicative of fraud, and a user previously unknown, or a host previously unknown or not well known to a payee's host may be less trusted. A payee may also report fraudulent transactions to a registry server which can be used in fraud monitoring and may effect the level of a trust of a payor, host, or the like. Each of these levels of trust may be assigned weights or scores and, unless a threshold of trust is reached, the system itself, a payor or payee, or a host may determine via manual or automatic methods whether to allow the transaction to move forward at this or other stages of the transaction.

In step 360, an invoice 370 is generated. An invoice may be any authenticable data which comprises information that can be interpreted by devices of the disclosed technology or a person as a request to send or receive money. In embodiments of the disclosed technology, the invoice and other data transferred between hosts or financial institutions are encrypted or electronically signed documents which may be in XML (extensible markup language) or other formats readable by a computing device with a proper key and verifiable for authenticity by each host. A typical invoice, such as invoice 370, may comprise any or all of the following—an ID number of the payor, an ID number of the payee, date and time (a timestamp) when the invoice or request for payment was generated, a unique document number derived based on other information in the document, a unique document number based on a randomly generated number, an amount due, a minimum amount due (e.g., $15 minimum payment for a $1000 invoice), a date due, description, code for displaying the invoice (such as HTML code), a text field for more information, and payment method information (bank account information, credit card information, PayPal or Google Checkout credentials, etc.).

In step 380, the invoice is sent to the payor. Referring to FIG. 1 or 2, in an embodiment of the disclosed technology, this is accomplished by host 130 communicating over an IP network with host 120, the later being the host associated with or having the user account of user 122, the payor. The invoice is then interpreted by software executed on the host's 120 or user's 122 computing device. The invoice, in embodiments of the disclosed technology, appears in an “inbox,” a list dedicated to providing invoices where a user can, for example, click “pay” or a similar button to schedule a payment to take place. Such a list may be part of an accounts receivable or payable system of a user's accounting software, whether residing on the user's local computer, on a host server, a web interface, or combination thereof. The host 120 or the user 122 (or a computing device under at least partial control of the user 122), by way of preconfigured actions, may respond automatically to the invoice and initiate payment, or user intervention may be required to send a payment, such as immediately or on the due date of the invoice.

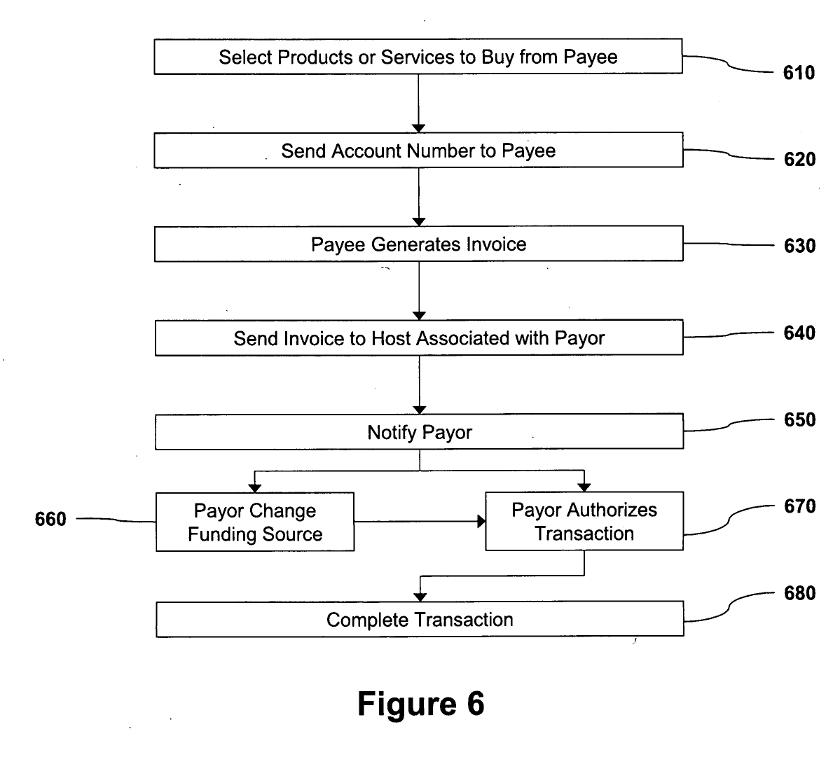

FIG. 6 shows the steps taken in an embodiment of the disclosed technology where a payor causes an invoice to be generated. In step 610, the payee selects products or services to be purchased from payee. For example, a person browsing a website may select products for purchase and place them into a shopping cart, as is known in the art. The payor then sends his unique account number in step 620, that is, an account number used with the disclosed technology, and an invoice is generated by the payee in step 630. The account number may be pre-provided by the payee, so that a selection of an item triggers the invoice generation. In embodiments of the invention, the invoice is then sent, in step 640 to a host associated with the payee by way of the methods and devices described above, and the payor is notified in step 650. The payee notification may be in the form of a text message, e-mail, or be placed in the user's software or front-end, whether running as software on his computing device or on a web server, whereby the payor may elect to change the funding source (step 660), with the limitation that it must be one accepted by both parties, and then in step 670, the payor authorizes the transaction, such as by clicking a button that says “authorize,” and the transaction is completed in step 680 whereby the system begins a payment authorization transaction and then completes the transaction.

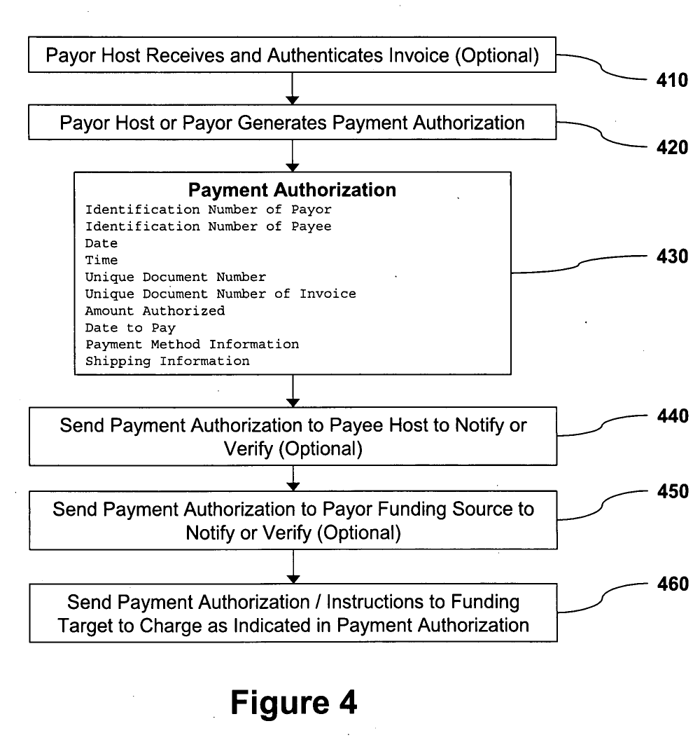

FIG. 4 shows the steps taken to generate a payment authorization in an embodiment of the disclosed technology. Before describing this figure, it should be understood that a payor may elect to send a payment without receiving an invoice or request to pay. In such instances, steps described above with respect to FIG. 3 may be carried out by a payor, whereby the payor initiates the verification and data gathering steps, such as steps 320 through 350. Whether or not the payment authorization is in response to an invoice, the method of authorizing the sending of a payment proceeds as follows, in embodiments of the disclosed technology.

In step 410 of FIG. 4, in an embodiment of the invention, the payor's host (such as host 120) receives and authenticates a payment authorization (as described with reference to FIGS. 1 and 2), such as by contacting the host server of the payor and verifying that all data are correct and that the user has an account in good standing on the host server. In step 420, the payor's host (such as host 120) or the payor (such as user 122) generates a payment authorization. The payment authorization, in embodiments of the disclosed technology, is an authenticated document comprising information which may be read as instructions to authorize sending money from a payor to a payee. An example of the data which may be part of a payment authorization document 430 is shown. The payment authorization document 430 may have one or all of the following—ID number of the payor, ID number of the payee, date and time (e.g., a timestamp when the document is generated), a unique document number generated from the above or other data, a unique document number of the invoice for which the payment authorization is being sent in response (where applicable), an amount authorized for payment, a date to pay the money (e.g., withdrawal from an account of the payor or received to an account of the payee), payment method information (as described with reference to FIG. 3), and shipping or billing address information.

In some embodiments of the disclosed technology, step 440 is carried out, whereby the generated payment authorization document 430 or data is sent to a payee's host. This may include all or a part of the payment authorization data, such as just the unique document number and amount of the invoice being paid, or the entire generated content. This information may be verified for accuracy by the payee's host and/or the payee, and may be in the form of a notification or require action on the part of the payee or payee's host, whether automated or manual, to allow the payment to be received. The payee or payee's host can have this payment authorization received by a gateway executed on a local machine, such as accounting software for purposes of tabulating income and the like. In this manner, fraud can be limited, because even if the system is partially compromised by a fraudulently authenticated invoice, the payment requires a separate authorization between known hosts, and a rogue host can be shut down at the level of one or more registry servers 110.

Another advantage of the disclosed technology is that the payee need not necessarily know the payor's account information. While the information may be transmitted within a payment authorization document 430, such information may not be transmitted or may be unreadable by a payee. The payment information may be sent only to a host such as host 130 or 140, which can then process the payment with a financial institution, or where available, to a financial institution capable of acting upon and sending funds using systems and methods of the disclosed technology.

In optional step 450, in embodiments of the disclosed technology, the payment authorization 430 (or a part thereof) is sent to the payor's funding source, where the payor's funding source is familiar with protocols and the like used in embodiments of the disclosed technology. The funding source may verify that there are enough funds or credit to pay the designated amount in the payment authorization 430 and/or may require receipt of such an authorization before allowing a payment to be drawn.

In step 460, either the payment authorization 430 (or a part thereof) and/or other instructions are sent to the funding target (such as funding target 150 of FIG. 2) which are, or are interpreted by the funding target as, an authorization and instructions to charge the amount indicated. That is, the amount indicated in, for example, the payment authorization 430 is withdrawn from or charged to an account provided by the payor (such as payor 122) and placed into an account held or operated by the financial institution 150. Upon doing so, the host which sent such instructions, such as the host associated with the payor, the financial institution, or other entity, such as is shown in FIGS. 1 and 2, may be notified or sent a request for verification, and the funds transfer may be initiated.

It should be understood that depending on the usage of the disclosed technology, a financial institution of a payee may initiate the transfer of funds (e.g. credit card or check payment) or a financial institution of a payor may initiate the transfer of funds (e.g. PayPal or Google Checkout). Depending on the specific usage, either method can be carried out, as necessary, with the disclosed technology.

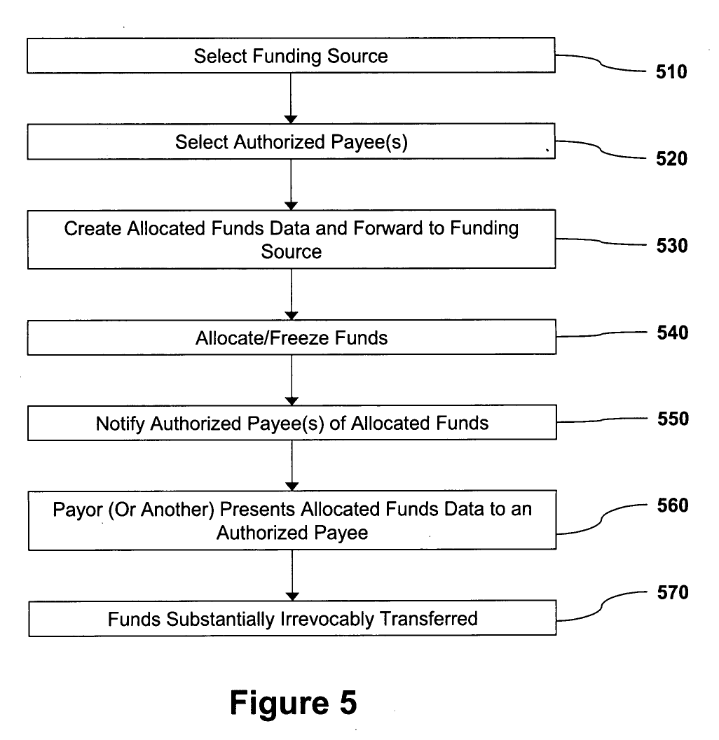

FIG. 5 shows steps taken to pre-allocate and pre-authorize funds from a funding source to a payee in an embodiment of the disclosed technology. Such transactions are pre-authorized and may be reviewed by a payee (such as a merchant) before the transaction takes place, and the funds may be frozen and guaranteed. In short, such an embodiment may have a trust level similar to a cashier's check, or almost that of money held in escrow, and may be used to raise a trust level of a payor to an acceptable level. Thus, a payor whose payment may not be accepted via other embodiments of the disclosed technology may be trusted to pay when using the embodiment shown in FIG. 5. Still further, such a transaction, at checkout time, may be sped up because the data and the authorization have already been received by the payee. It may also be used when there is a fear of loss of cash or when giving money to a child or employee, to ensure the money is spent only at an authorized location. Still further, such an embodiment may be used for the purpose of a gift card, that is, a pre-authorization of a funds transfer from a payor which will be carried out by a second payor.

Referring to the steps shown in FIG. 5, in step 510 a funding source, such as funding source 150 of FIG. 2, or any one of a bank account, PayPal account, credit card, or the like, is selected. This selection typically is carried out by a payor, that is, a person associated with the funding source selected. In step 520, one or a plurality of authorized payees, such as a merchant 132, 142, and/or 144 is selected. One payee may be desired for some transactions such as those involving large payments, perhaps as for down payments on a house and the like. Steps 510 and 520 may be carried out as part of a selection of a purchase of a gift card. Then, allocated funds data, such as in the form of an encrypted data file, similar to a payment authorization 430 or an invoice 370, is generated based on the information provided in steps 510 and 520. The data is sent to the funding source (funding source 150 in this example) which reads and interprets the data, in step 540, as instructions for freezing, setting aside, or allocating the requested amount of funds for receipt by one or more of the payees selected in step 520. The funds, in step 540, may be transferred into an escrow account located at the funding source or at another financial institution. The funding source (or host associated with a funding source) may deny any payments to another, whether through embodiments of the disclosed technology or otherwise, involving the allocated money, unless the transaction meets the criteria selected in steps 510 and 520 and/or matches a transaction ID generated in step 530 with the allocated funds data. An expiration date may be set whereby the funds allocation for a specific payee or group of payees expires if not used by a certain date, and the funds may now be used for other purposes.

In step 550, the authorized payees, that is, the payee or payees selected in step 520, are notified of the allocated funds. Alternatively, the host associated with the payor may store such information as allowable transactions (types of payment and/or payees) which can be used with the allocated funds. Attempting to make a non-allowable transaction may lower a trust level of any of the involved parties. An additional pre-confirmation step, whereby each notified payee verifies receipt of the data and/or that it will accept a transaction based on the allocated funds, may also take place. In this manner, the payor and payee will each know that the other party will accept the transaction. Such a pre-confirmation may have an expiration date and may be an “escrow replacement” whereby large amounts of money, such as for a closing on a piece of property, can be pre-confirmed by both parties and transferred at the appropriate time. A host associated with a payor or payee may confirm verification on behalf of a respective payor or payee.

Now, in step 560, the payor can present allocated funds data to an authorized payee who can use the data to effect the transaction. In step 570, the funds are substantially irrevocably transferred, meaning that the transaction can only be reversed upon proof of fraud.

Referring again to step 560 in more detail, embodiments of the disclosed technology allow a payor to present allocated funds data to an authorized payee in a number of ways. The data, in an embodiment of the disclosed technology, is on an electronic device, such as handheld personal digital assistant or telephone (i.e., iPod, cellular phone), a readable magnetic strip, or any other data carrying devices known in the art. In another embodiment of the disclosed technology, the data is a code, such as a series of alphanumeric characters and/or a barcode which may be used by the payor (or a third party spending the payor's money, such as in the case of a gift card, child, or employee) which is read by the merchant. The transaction can only be completed if the merchant is pre-authorized, and more than one merchant may be authorized for use with a particular transaction in embodiments of the disclosed technology. When the funds are used up or insufficient for a second transaction, the payee is made aware and the transaction is denied, either as the funds are used (or, for example, at the end of each business day or each week) or when the transaction, using such a code or information pertaining to the allocated funds, is attempted.

Referring now to FIGS. 1 and 2, an example of an implementation of FIG. 5 is as follows. In this example, the payor is an office manager and the payees are merchants which provide supplies for the office. In step 510, a payor 122 selects funding source 152 and selects payees 132, 134, and 142, the merchants, as potential payees. Then, a data file is generated by host 130 (the host associated with the payor) in step 530. The data file comprises a variation of payment authorization 430 (see FIG. 4) whereby an additional datum is used to point out that a transaction up to the amount indicated may be charged in the future, using data comprising the unique document number, and the funds are allocated for this purpose at funding source 152, such as by sending the generated data to a host associated with the funding source for carrying out these instructions. If the funding source 152 is incapable of interpreting such instructions, then the money may simply be taken out and placed into an escrow account managed by a host, such as host 140 or a host designated solely for such a purpose. In step 560, an employee takes a print-out of the data with the associated unique codes, the data file on a USB memory key, a magnetic card with the unique codes imprinted on it, or any other form of exhibiting the data, and goes to the store of one of the payees. The payee then takes the data and reads it, such as with a card reader or a software interface into his account on a host, and will confirm that such a transaction is authorized and/or that money has already been allocated for this transaction. Finally, in step 570, the transaction takes place and the funds are transferred from the funding source 152 to a funding target, such as funding target 154.

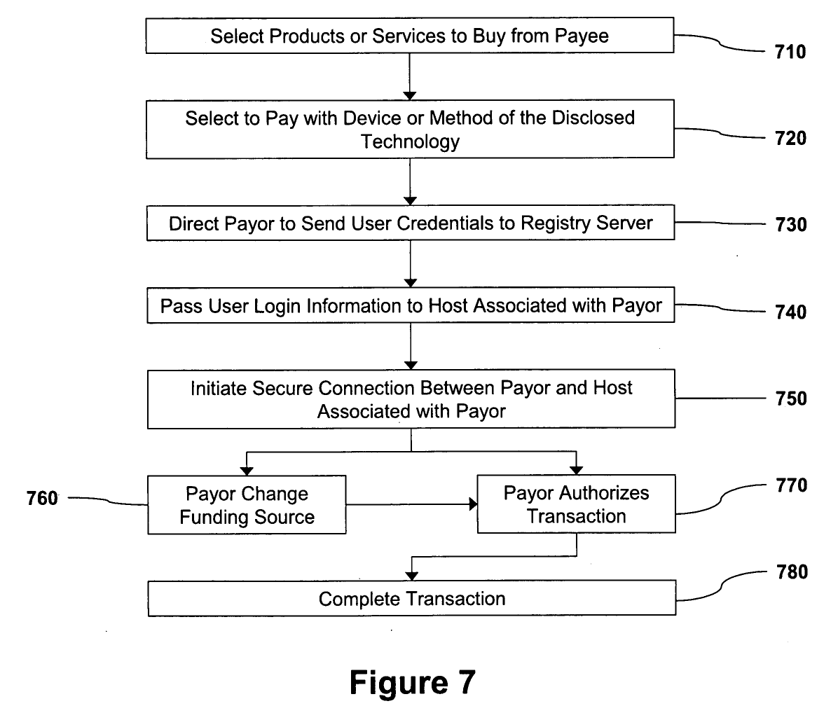

FIG. 7 shows the steps taken to authorize a transaction when a payor interacts with a payee website in an embodiment of the disclosed technology. It should, of course, be understood that the steps shown in FIG. 7 are just one of many methods contemplated to complete a transaction in such scenario. FIG. 4, by way of example, shows another method which may be used.

In step 710, products and/or services are selected from a payee database, such as via a website interface showing products for sale. In step 720 (which may take place before or after step 710), the payor indicates a desire to pay using the devices and methods of the disclosed technology, such as shown and described with reference to FIGS. 1-4. Upon completion of steps 710 and 720 (wherein the payor may indicate his intention, i.e., by clicking “Buy Now”), in step 730, the payor is directed to a registry server or website associated with a registry server. Further, when step 730 is carried out, transaction and merchant information may be passed to the registry server. The registry server used with reference to step 730 may be any computing device associated with a registry server or a main registry server, and is typically operated by the same corporate entity as a registry server or the main registry server. In this manner, the payor is sending his login information to a trusted entity and not to the payee directly. (The payor may also choose to indicate where his account is hosted, so that the payee website directs the payor to the payor's host for sending the credentials in step 730.)

Once the user sends his credentials, such as a login name and password or account number and password, in step 740, the user credentials and, if applicable, transaction and merchant information, are passed to the host associated with the payor. In step 750, a secure connection is initiated between the payor and host associated with the payor, such as via a web interface or an interface with software installed on the payor's computing device. In the latter case, steps 730 and 740 would be skipped and instead, this may be accomplished by associating a certain file extension or web hyperlink type with a user's software whereby, when the file is downloaded, the information causes the user software to launch with the appropriate information for authorizing the present payment. In either instance, in step 760, the payor may elect to change the funding source or proceed directly to step 770 where the payor authorizes the transaction, whereby the transaction is completed in step 780. The payor's software or web interface may be accounting software, so that the accounting is automatically updated upon a purchase using the disclosed technology.

It is further contemplated and within the scope and spirit of the disclosed technology to use the disclosed technology when a payor pays without using the transaction layer disclosed herein, but the funding source does use such technology. Such a payor may pay, for example, using a credit card or check. The funding source, such as the bank or credit card company, uses embodiments of the disclosed technology. In such a case, the funding source may automatically send out a receipt to the payor which may be used by the payor's accounting software to automatically reconcile the transaction. In addition, the funding source and the payee may negotiate the payment using embodiments of the disclosed technology which allows the parties extra security and a single platform to use for processing monetary transactions between each other.

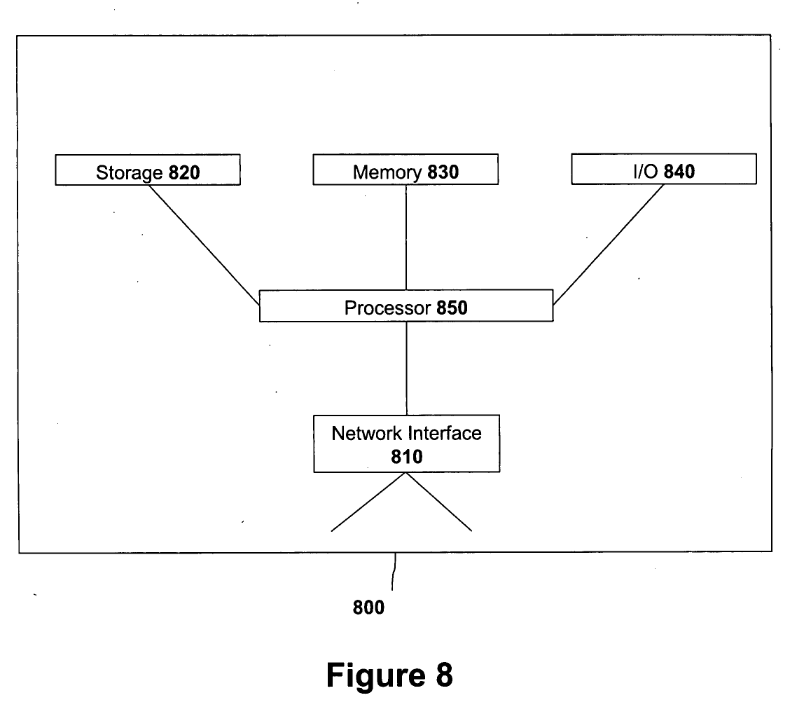

FIG. 8 shows a high-level block diagram of a computer that may be used to carry out the disclosed technology. Computer 800 contains a processor 804 that controls the overall operation of the computer by executing computer program instructions which define such operation. The computer program instructions may be stored in a storage device 808 (e.g., magnetic disk, database) and loaded into memory 812 when execution of the computer program instructions is desired. Thus, the computer operation will be defined by computer program instructions stored in memory 812 and/or storage 808, and the computer will be controlled by processor 804 executing the computer program instructions. Computer 800 also includes one or a plurality of input network interfaces for communicating with other devices via a network (e.g., the internet). Computer 800 also includes one or more output network interfaces 816 for communicating with other devices. Computer 800 also includes input/output 824, representing devices which allow for user interaction with the computer 800 (e.g., display, keyboard, mouse, speakers, buttons, etc.).

One skilled in the art will recognize that an implementation of an actual computer will contain other components as well, and that FIG. 8 is a high level representation of some of the components of a computer or switch and are for illustrative purposes. It should also be understood by one skilled in the art that the method and devices depicted or described in FIGS. 1 through 7 may be implemented on a device such as is shown in FIG. 8.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

We claim:

1. A method of completing a transaction comprising:
receiving authenticated information, said information comprising a request to transfer funds from a payor to a payee;
sending a request to a registry server for host data associated with said payor;
exchanging authenticated information with a host associated with said payor based on said request to a registry server;
sending at least some of said authenticated information to a funding target associated with a payee; and
upon approval, sending instructions to initiate a transfer of funds from a funding source associated with said payor to said funding target.

2. The method of claim 1, wherein said payor is associated with a first host and said payee is associated with a second host.

3. The method of claim 2, wherein said first host is operated by a first company and said second host is operated by a second company.

4. The method of claim 1, wherein said request to transfer funds comprises a selection of said funding source, and said funding source is selected from the group consisting of a check, a bank wire transfer, a credit card, and an electronic account.

5. The method of claim 1, wherein said approval comprises automated approval based on a trustworthiness threshold of at least said payor.

6. The method of claim 1, wherein said approval is provided by said payor.

7. The method of claim 1, further comprising a step of sending an authenticated receipt at least to said payor and said payee.

8. The method of claim 7, wherein upon said payor or said payee receiving said receipt, accounting information of said payor or payee is updated.

9. The method of claim 1, wherein credentials of a payor are received by a said registry server.

10. The method of claim 1, wherein a transaction between a payor and payee is pre-authorized and said transaction is substantially irreversible upon a payor or third party presenting a unique transaction number to said payee.

11. A device for aiding a transaction comprising:
means for receiving authenticated information, said information comprising a request to transfer funds from a payor to said payee;
means for sending a request to a registry server for host data associated with said payor;
means for exchanging authenticated information with a host associated with said payor based on said request to a registry server;
means for sending at least some of said authenticated information to a funding target associated with a payee; and
upon approval, means for sending instructions to initiate a transfer of funds from a funding source associated with said payor to said funding target.

12. The device of claim 11, wherein said payor is associated with a first host and said payee is associated with a second host.

13. The device of claim 12, wherein said first host is operated by a first company and said second host is operated by a second company.

14. The device of claim 11, wherein said request to transfer funds comprises a selection of said funding source, and said funding source is selected from the group consisting of a check, a bank wire transfer, a credit card, and an electronic account.

15. The device of claim 11, wherein said approval comprises automated approval based on a trustworthiness threshold of at least said payor.

16. The device of claim 11, wherein said approval is provided by said payor.

17. The device of claim 11, further comprising a step of sending an authenticated receipt at least to said payor and said payee.

18. The device of claim 17, wherein upon said payor or said payee receiving said receipt, accounting information of said payor or payee is updated.

19. The method of claim 11, wherein credentials of a payor are received by a said registry server.

20. The method of claim 11, wherein a transaction between a payor and payee is pre-authorized and said transaction is substantially irreversible upon a payor or third party presenting a unique transaction number to said payee.

21. A computer readable storage medium comprising:
instructions for receiving authenticated information, said information comprising a request to transfer funds from a payor to said payee;
instructions for sending a request to a registry server for host data associated with said payor;
instructions for exchanging authenticated information with a host associated with said payor based on said request to a registry server;
instructions for sending at least some of said authenticated information to a funding target associated with a payee; and
instructions for determining if the transaction is approved and sending instructions to initiate a transfer of funds from a funding source associated with said payor to said funding target.

22. The computer-readable storage medium of claim 21, wherein said payor is associated with a first host and said payee is associated with a second host.

23. The computer-readable storage medium of claim 22, wherein said first host is operated by a first company and said second host is operated by a second company.

24. The computer-readable storage medium of claim 21, wherein said request to transfer funds comprises a selection of said funding source, and said funding source is selected from the group consisting of a check, a bank wire transfer, a credit card, and an electronic account.

25. The computer-readable storage medium of claim 21, wherein said approval comprises automated approval based on a trustworthiness threshold of at least said payor.

26. The computer-readable storage medium of claim 21, wherein said approval is provided by said payor.

27. The method of claim 21, wherein credentials of a payor are received by a said registry server.

28. The method of claim 21, wherein a transaction between a payor and payee is pre-authorized and said transaction is substantially irreversible upon a payor or third party presenting a unique transaction number to said payee.
